(19) United States
(12) Patent Application Publication
(10) Pub. No.: US 2012/0315496 A1
(43) Pub. Date: Dec. 13, 2012

(54) METHOD OF FORMING AN OXIDE COATING THAT REDUCES ACCUMULATION OF RADIOACTIVE SPECIES ON A METALLIC SURFACE

(75) Inventors: Young Jin Kim, Clifton Park, NY (US); Anthony Yu-Chung Ku, Rexford, NY (US); Rebecca Christine Malish, Schenectady, NY (US); Thomas Alfred Caine, San Jose, CA (US); Lauraine Denault, Nassau, NY (US); Anthony Thomas Barbuto, Troy, NY (US); Catherine Procik Dulka, West Chester, PA (US); Patrick Daniel Willson, Latham, NY (US); Peter Louis Andresen, Schenectady, NY (US)

(73) Assignee: GENERAL ELECTRIC COMPANY, Schenectady, NY (US)

(21) Appl. No.: 13/154,702

(22) Filed: Jun. 7, 2011

(51) Int. Cl. B05D 3/02; B32B 15/04; B82Y 30/00

(52) U.S. Cl. 428/469; 427/380; 977/773

(57) ABSTRACT

A method of forming an oxide coating for reducing the accumulation of radioactive species on a metallic surface exposed to fluids containing charged particles is disclosed. The method includes preparing an aqueous colloidal suspension containing about 0.5 to about 35 weight percent of nanoparticles that contain at least one of titania and zirconia, and about 0.1% to about 10% 2-[2-(2-methoxyethoxy)ethoxy]acetic acid (C₇H₁₄O₅) or polyfluorosufonic acid in water, depositing the aqueous colloidal suspension on the metallic surface, drying the aqueous colloidal suspension to form a green coating, and then heating the green coating to a temperature of up to 500° C. to densify the green coating to form an oxide coating having a zeta potential less than or equal to the electrical polarity of the charged particles so as to minimize deposition of the charged particles on the metallic surface. The nanoparticles have a diameter of up to about 200 nanometers.

### BACKGROUND OF THE INVENTION

The invention relates generally to coatings and methods for their deposition. More particularly, the invention relates to a ceramic coating for use in an aqueous environment to inhibit the accumulation of deposits of metal surfaces within the aqueous environment, and to a process for forming the ceramic coating using a colloidal-based process so that the ceramic coating is dense, has a controlled thickness, and exhibits a zeta potential of equal to or less than the electrical polarity of the primary deposits of concern.

Components that are exposed to high temperature water environments, for example, nozzles and throat areas of jet pump assemblies, impellers, condenser tubes, recirculating pipes, and steam generator parts in boiling water nuclear reactors, are subject to fouling that results from charged particles within the hot coolant (typically water at about 100 to about 300° C.) being deposited onto the metal surfaces of the components. Over time, fouling results in the formation of a thick, dense oxide “crud” layer on the exposed surfaces of the component. The accumulation of foulants is a serious operational and maintenance issue for boiling water nuclear reactors, for example, because foulant accumulation degrades the efficiency of the cooling flow recirculation system of a reactor by substantially reducing flow velocities of the coolant (water) and reducing the performance of the cooling flow system. In addition to foulant accumulation, components are also susceptible to the accumulation of radioactive material on their surfaces, for example, radioactive species of cobalt entrained in the coolant. Foulants are typically removed from the surfaces of boiling water nuclear reactor components during regularly scheduled shutdowns of the reactor. However, this approach is costly and does nothing to maintain the efficiency of the cooling flow recirculation system between shutdowns. Therefore, it would be desirable to develop a coating that was particularly well suited to minimize or eliminate the fouling rate on the surfaces exposed to high temperature water environments.

### BRIEF DESCRIPTION

The inventors of the present application have solved the problem of minimizing or eliminating the fouling rate on components exposed to high temperature water environments by developing an aqueous-based coating and a method for depositing the coating on components surfaces to minimize or eliminate the fouling rate of radioactive species on the component surface.

Briefly, in accordance with one embodiment, a process forms an oxide coating on a metallic surface to reduce the deposition of charged particles on the metallic surface when contacted by a coolant containing the charged particles. The process includes preparing an aqueous colloidal suspension containing about 0.5 to about 35 weight percent of nanoparticles that contain at least one of titania and zirconia, depositing the aqueous colloidal suspension on the metallic surface, drying the aqueous colloidal suspension to form a green coating, and then heating the green coating at a temperature of up to 500° C. to densify the green coating and yield the oxide coating having a zeta potential less than or equal to the electrical polarity of the charged particles so as to minimize deposition of the charged particles on the metallic surface.

Other aspects of the invention include coatings formed by the process described above, as well as components protected by such coatings. The coating is well suited for protecting various types of metallic surfaces from fouling that can result from particles often present in coolants, for example, coolant water used in boiling water nuclear reactors. Nonlimiting examples are components formed of nickel-based alloys, iron-based alloys, stainless steels, for example, AISI Type 304 stainless steel, notable examples of which include nozzles and throat areas of jet pump assemblies, impellers, condenser tubes, recirculating pipes and steam generator parts of boiling water nuclear reactors.

A notable aspect of the process and the resulting coating is that the coating can be produced to be dense, have a controlled thickness, and have a zeta potential at its surface that enables the coating to significantly minimize the deposits of charged particles, including radioactive species as well as foulants typically present in coolant water. The ability to apply the coating using a colloid-based process facilitates the ability of the coating to be applied to components that have already been in service, in that the colloid-based process of this invention does not require extensive equipment and extreme processing parameters, for example, temperatures and pressures, as compared to other deposition processes, such as chemical vapor deposition (CVD), physical vapor deposition (PVD), and the like, and is not limited by line-of-sight and other geometric constraints as is CVD processes. In addition, the colloid-based process of this invention is also capable of providing a significant cost advantage relative to CVD and other typical processes that are commonly employed to deposit similar ceramic coatings.

In one aspect, a method of forming an oxide coating, comprises preparing an aqueous colloidal suspension containing about 0.5 to about 35 weight percent of nanoparticles comprising one of titania and zirconia; depositing the aqueous colloidal suspension on a metallic surface; drying the aqueous colloidal suspension to form a green coating; and heating the green coating to a temperature of up to 500° C. to densify the green coating and form an oxide coating on the metallic surface, whereby the oxide coating has a zeta potential less than or equal to an electrical polarity of charged particles in contact with the oxide coating so as to minimize deposition of the charged particles on the metallic surface.

In another aspect, a method for inhibiting deposition of charged particles on a metallic surface comprises preparing an aqueous colloidal suspension containing about 0.5 to about 35 weight percent of nanoparticles that contain at least one of titania and zirconia in water and about 0.1 to about 10% of 2-[2-(2-methoxyethoxy)ethoxy]acetic acid (C₇H₁₄O₅) or polyfluorosufonic acid; immersing a metallic object in the aqueous colloidal suspension for a duration of about 1 to about 120 minutes; withdrawing the metallic object from the aqueous colloidal suspension at a rate of about 1 to about 10 centimeters/minute; drying the aqueous colloidal suspension to form a green coating on the object; and heating the green coating to a temperature of up to 500° C. to densify the green coating and form an oxide coating with a thickness of about 0.1 to about 10.0 micrometers and a zeta potential less than or equal to an electrical polarity of charged particles in contact with the metallic object so as to minimize deposition of the charged particles on the metallic object.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIGS. 1(a), (b) and (c) are microphotographs of an oxide coating produced from an aqueous colloidal suspension containing about 35 weight percent of titania nanoparticles and fired at a temperature of about 500° C.;

FIGS. 2(a) and (b) are microphotographs of an oxide coating produced from an aqueous colloidal suspension containing about 35 weight percent of titania nanoparticles and fired at a temperature of about 150° C.;

FIGS. 3(a) and (b) are microphotographs of an oxide coating produced from an aqueous colloidal suspension containing about 35 weight percent of titania nanoparticles and fired at a temperature of about 100° C.;

FIGS. 4(a) and (b) are microphotographs of an oxide coating produced from an aqueous colloidal suspension containing about 10 weight percent of titania nanoparticles and fired at a temperature of about 100° C.;

FIGS. 5(a), (b) and (c) are microphotographs of oxide coatings produced by applying aqueous colloidal suspensions containing about 10, 20 or 35 weight percent of titania nanoparticles, respectively, on rotating surfaces, and then heating the coatings at a temperature of about 100° C.;

FIG. 6 schematically represents a cross-sectional view of a portion of a jet pump of a type used to recirculate coolant through a reactor pressure vessel of a boiling water nuclear reactor; and

FIG. 7 is an enlarge fragmentary cross-sectional view of a nozzle of the jet pump of FIG. 6.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

There are many different chemical forms of “crud,” for example, Fe₂O₃, Fe₃O₄, NiFe₂O₄, Fe₂Cr₂O₄, and the like. The most critical radioactive species in a nuclear reactor environment is Co-60 that normally is present as an ionic species in bulk reactor water. Once Co-60 deposits on the crud or oxide layer of metallic components, Co-60 reacts with other crud/oxide to form CoFe₂O₄ (radioactive crud). The fast diffusion of Co ions as compared to any other metallic ions, for example, Fe, Ni, Cr, and the like, easily replaces Fe, Ni, or Cr and forms CoFe₂O₄. Because a TiO₂ coating is chemically stable, the chemical reactions can be dramatically reduced and mitigates the formation of CoFe₂O₄ (radioactive crud). Some other oxides or crud, such as Fe₂O₃, and the like, may deposit on the TiO₂ coating layer, but they are not going to react kinetically with TiO₂.

According to an aspect of the invention, the accumulation of radioactive species, such as Co-60 and the like, on the surfaces can be mitigated by a coating that is deposited on the surface of the component of interest, for example, on a metal surface of a component of a nuclear reactor that may come into contact with the radioactive species. In one embodiment, the coating is a dense oxide coating having a controlled thickness and a zeta potential that is approximately identical to or less than the electrical polarity of radioactive species, for example, radioactive species that are typically present in coolants flowing through a boiling water nuclear reactor. The coating is preferably deposited from an aqueous-based colloidal suspension of nanoparticles that consist of or at least contain titanium oxide (titania; TiO₂) and/or zirconium oxide (zirconia; ZrO₂). The colloidal suspension is applied to the surfaces to be coated, and then dried and heat treated at an elevated temperature to increase its density and adhesive strength. To achieve a dense oxide coating having a controlled thickness, various aspects of this process are believed to be important individually and/or in combination, such as the chemistry of the colloidal suspension, the application method, the drying conditions, and the heat treatment temperature. These aspects are discussed below.

By definition, a colloid is a homogeneous, noncrystalline substance consisting of large molecules or ultramicroscopic particles of one substance dispersed through a second substance. Colloids include gels, sols, and emulsions; the particles do not settle and cannot be separated out by ordinary filtering or centrifuging like those in a suspension. In other words, colloidal suspensions (also referred to as colloidal solution or simply colloid) are a type of chemical mixture in which one substance is evenly dispersed throughout another. Particles of the dispersed substance are only suspended in the mixture, and not dissolved as in the case of a solution. The dispersed particles in a colloid are sufficiently small to be evenly dispersed in the other substance (for example, a gas, liquid or solid) to maintain a homogeneous appearance, but sufficiently large to not dissolve. In the present invention, the dispersed substance comprises nanoparticles of (or containing) titania and/or zirconia, and are dispersed in water as the preferred dispersion medium. The dispersed nanoparticles preferably have diameters of up to about 200 nanometers, more preferably less than 150 nanometers, and most preferably in a range of 2 to 50 nanometers. The colloidal suspension may contain about 0.5 to about 35 weight percent of the nanoparticles, more preferably about 5 to about 20 weight percent of the nanoparticles The colloidal suspension also preferably contains about 0.1% to about 10% of “2-[2-(2-methoxyethoxy)ethoxy]acetic acid (C₇H₁₄O₅) or polyfluorosufonic acid in water.

Deposition of the colloidal suspension can be performed by immersion, spraying, or various other methods, such as filling a cavity, though immersion techniques have been shown to achieve superior results in terms of surface morphology and controlling coating thickness, as well as facilitate the coating of surfaces that would be otherwise difficult to coat by a line-of-sight process. In preferred embodiments, the suspension is deposited by immersing the component in the suspension for a time sufficient to accumulate a suspension coating of a desired thickness. A suitable duration ranges from about 1 to about 120 minutes. By withdrawing the component from the suspension at a rate of up to 10 centimeters/minute, more preferably at a rate of about 1 to about 5 centimeters/minute, a layer of the suspension can be applied to controlled thicknesses of about 0.1 to about 10 micrometers, and more preferably about 0.5 to about 2.0 micrometers.

The layer of the colloidal suspension is then air dried to yield a green coating on the component surface. Air drying can be performed at roughly room temperature (about 25° C.) for up to about sixty minutes, for example, about thirty seconds to about thirty minutes and more preferably about one to ten minutes. The green coating then undergoes a heat treatment to densify the coating and yield a fully ceramic (oxide) coating. For this purpose, the green coating is preferably heated at a rate of about 1.0-10.0° C./minute, and preferably about 2-5° C./minute. The heat treatment temperature may be up to 500° C., for example, 100 to 500° C., though more preferably below 150° C., and most preferably in the range of 100 to 120° C. The heat treatment temperature is held for a duration of about 30 minutes to about 3 hours, more preferably about 45 minutes to about 1 hour. During the heat treatment, enhanced coagulation and sedimentation of the nanoparticules at high temperature.

The above parameters were determined through a multiple series of investigations with colloidal suspensions containing titania nanoparticles. In particular, these investigations indicated the importance of using relatively low concentrations of nanoparticles and relatively low heat treatments to promote the surface morphology, crack resistance and adhesion of the final ceramic coatings. In particular, lower concentrations and heat treatment temperatures were determined to improve the adhesion of the coating to levels of about 10 ksi (about 70 MPa) and greater, and to promote a crack-free and smoother coating surface that is less likely to promote the physical adhesion of radioactive species and foulants in the cooling water of a boiling water nuclear reactor.

In a first series of investigations, titania coatings were deposited on honed surfaces of Type 304 stainless steel specimens. The titania coatings were formed from either aqueous colloidal suspensions containing about 35 weight percent titania nanoparticles or from sol-gel solutions containing titanium isopropoxide as a titania precursor. Multiple specimens prepared from each coating type led to the conclusion that smooth, dense and adherent titania coatings were much more readily attainable with colloidal suspensions than sol-gel solutions.

In a second series of investigations, various colloidal suspensions were prepared from a colloidal suspension containing about 35 weight percent titania nanoparticles in water, with a reported particle size of less than 150 nanometers. From this solution, more dilute colloidal suspensions were prepared to contain 20% or 10% by weight of the titania nanoparticles. Test specimens for this first series of investigations were Type 304 stainless steel specimens whose surfaces were honed prior to coating.

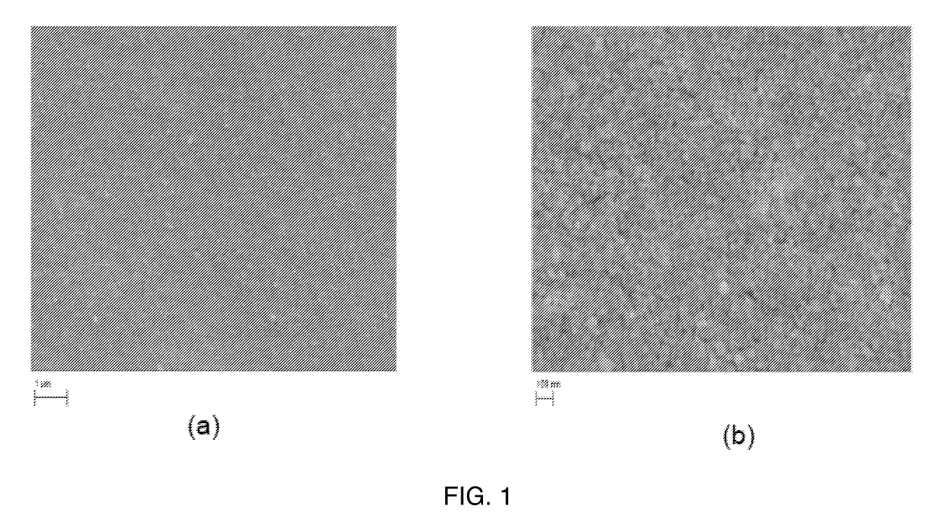

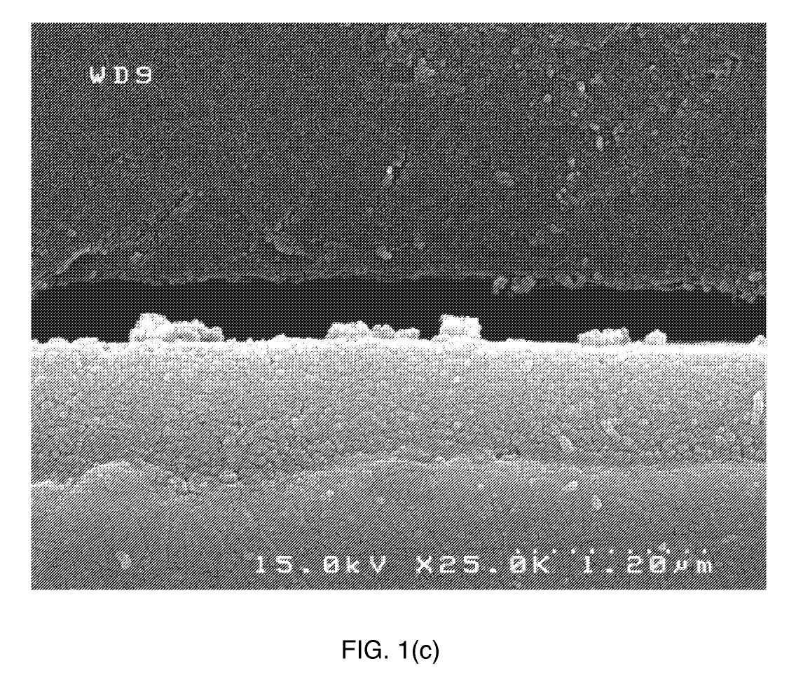

Titania coatings were formed on a first group of the specimens by immersing the specimens in the 35% colloidal suspension for about 30 minutes, withdrawing the specimens at a rate of about 1.0 centimeters/minute, air drying for about 5 minutes, and then heating the resulting green coatings at a temperature of about 500° C. for a duration of about 60 minutes. The resulting ceramic coatings had thicknesses of about 0.5 to about 1.0 micrometers. FIGS. 1(a) and (b) are microphotographs of the surface of one of the coatings taken at magnifications of 10k× and 50k×, respectively, and FIG. 1(c) is a microphotograph showing a cross-section of the specimen at a magnification of 20k×. An adhesion test performed on the specimen showed the coating to have an adhesion strength of about 11.3 ksi (about 78 MPa).

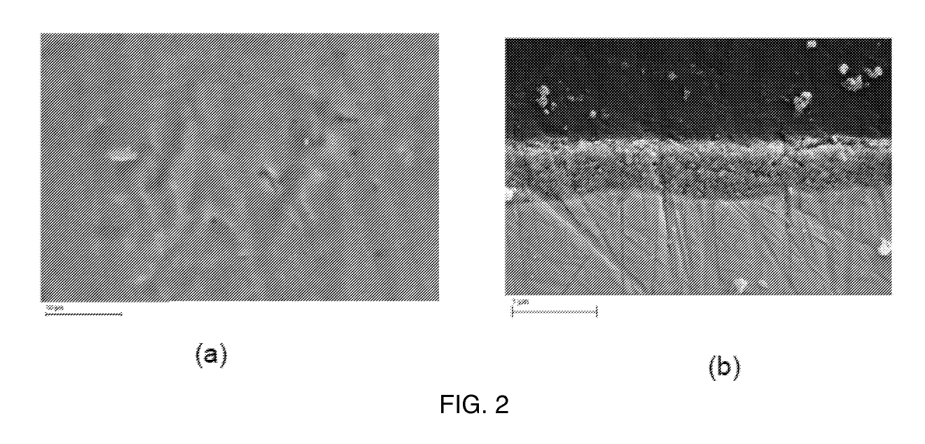

Titania coatings were formed on a second group of specimens by immersing the specimens in the 35% colloidal suspension for about 30 minutes, withdrawing the specimens at a rate of about 1.0 centimeters/minute, air drying the coatings for about 5 minutes, and then heating the coatings at a temperature of about 150° C. for a duration of about 60 minutes. The resulting coatings had thicknesses of about 0.5 to about 1.0 micrometers. FIGS. 2(a) and (b) are microphotographs of the surface and cross-section of one of the coatings taken at magnifications of 5k× and 25k×, respectively. The relatively lower temperature (150° C. as compared to 500° C.) still provided acceptable coating properties. An adhesion test performed on the specimen showed the coating to have an adhesion strength of about 9.8 ksi (about 67 MPa).

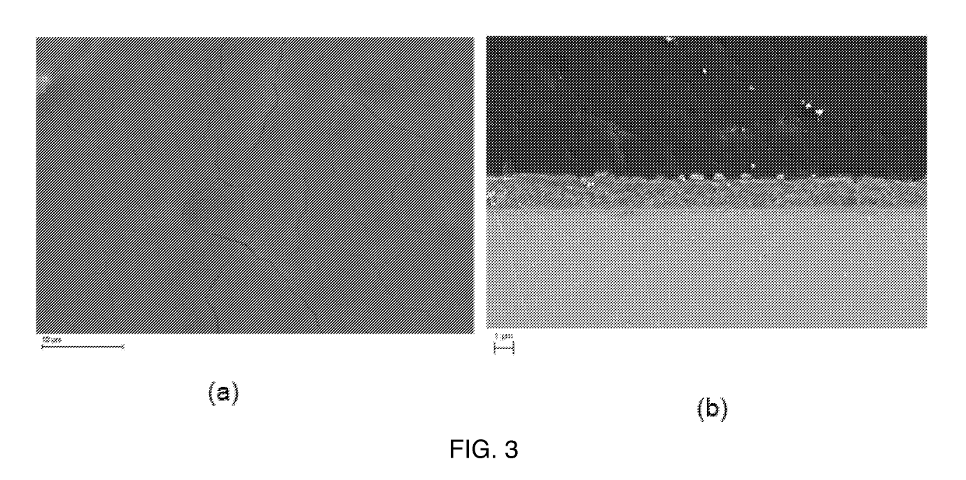

Titania coatings were formed on a third group of specimens by immersing the specimens in the 35% colloidal suspension for about 30 minutes, withdrawing the specimens at a rate of about 1.0 centimeters/minute, air drying the coatings for about 5 minutes, and then heating the coatings at a temperature of about 100° C. for a duration of about 60 minutes. The resulting coatings had thicknesses of about 0.5 to about 1.0 micrometers. FIGS. 3(a) and (b) are microphotographs of the surface and cross-section of one of the coatings taken at magnifications of 5k×. The relatively lower temperature (100° C. as compared to 500° C.) still provided acceptable coating properties. An adhesion test performed on the specimen showed the coating to have an adhesion strength of about 11.6 ksi (about 80 MPa).

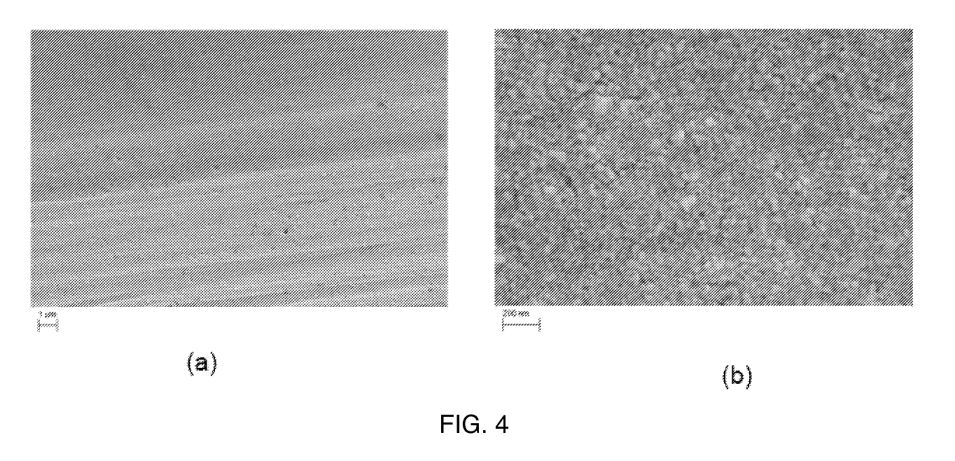

Titania coatings were formed on a fourth group of specimens by immersing the specimens in the 10% colloidal suspension for about 30 minutes, withdrawing the specimens at a rate of about 1.0 centimeters/minute, air drying the coatings for about 5 minutes, and then heating the coatings at a temperature of about 100° C. for a duration of about 60 minutes. The resulting coatings had thicknesses of about 0.5 to about 1.0 micrometers. FIGS. 4(a) and (b) are microphotographs of the surface and cross-section of one of the coatings taken at magnifications of 5k× and 50k×, respectively. The relatively lower colloidal percentage (10% as compared to 35%) still provided acceptable coating properties. An adhesion test performed on the specimen showed the coating to have an adhesion strength of about 11.5 ksi (about 79 MPa).

A third series of investigations was devised to further evaluate 100° C. heat treatments performed on titania coatings formed from aqueous colloidal suspensions containing 10%, 20% or 35% by weight titania nanoparticles. The particle size of the titania nanoparticles was about 30 to 40 nanometers. Test specimens for this series of investigations were Type 304SS tubes having a diameter of about 0.75 inch (about 19 mm) and whose interior surfaces were honed prior to coating.

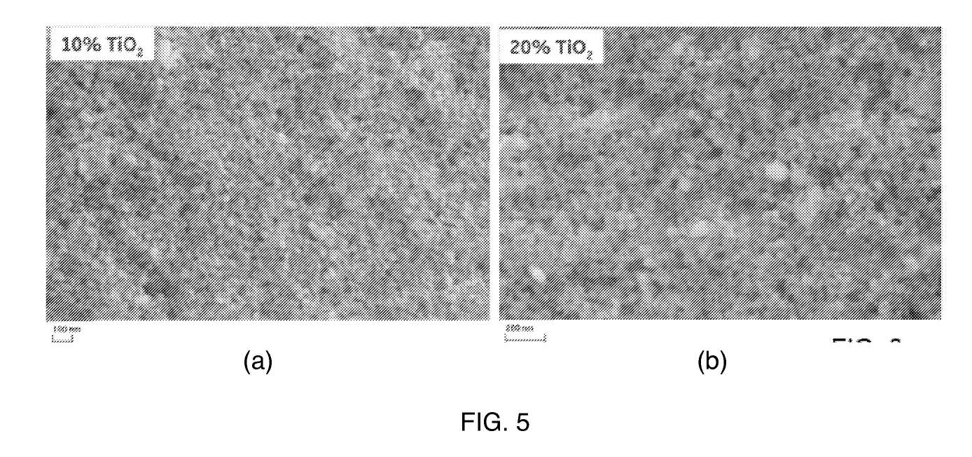

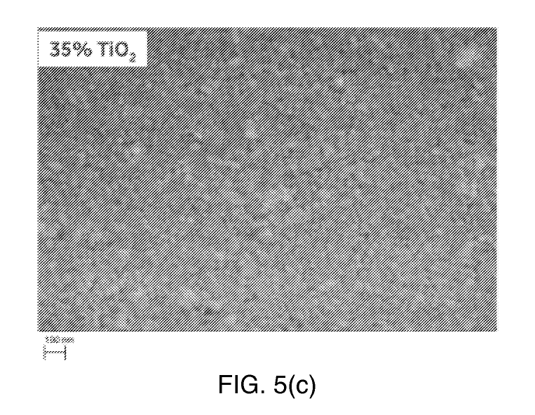

Titania coatings were formed on a first group of the 304SS tubes by rotating the tubes at a rate of about 125 rpm while dispensing either the 10%, 20% or 35% colloidal suspension into the interior of the tube. The tubes were rotated for about 30 minutes, after which the resulting colloidal coatings were air dried for about 5 minutes and then fired at a temperature of about 100° C. for about 1 hour. The resulting oxide coatings had thicknesses of about 0.5 to about 1.0 micrometers. FIGS. 5a, b and c are microphotographs of the surfaces of coatings formed from the 10%, 20% and 35% colloidal suspensions, respectively.

As mentioned above, components that are exposed to high temperature water environments, for example, nozzles and throat areas of jet pump assemblies, impellers, condenser tubes, recirculating pipes, and steam generator parts in boiling water nuclear reactors, are subject to fouling that results from charged particles within the hot coolant (typically water at about 100 to about 300° C.) being deposited onto the metal surfaces of the components. Over time, fouling results in the formation of a thick, dense oxide “crud” layer on the exposed surfaces of the component. The accumulation of foulants is a serious operational and maintenance issue for boiling water nuclear reactors, for example, because foulant accumulation degrades the efficiency of the cooling flow recirculation system of a reactor by substantially reducing flow velocities of the coolant (water) and reducing the performance of the cooling flow system. The process of the invention forms an oxide coating on a metallic surface to reduce the deposition of charged particles on the metallic surface when contacted by a coolant containing the charged particles

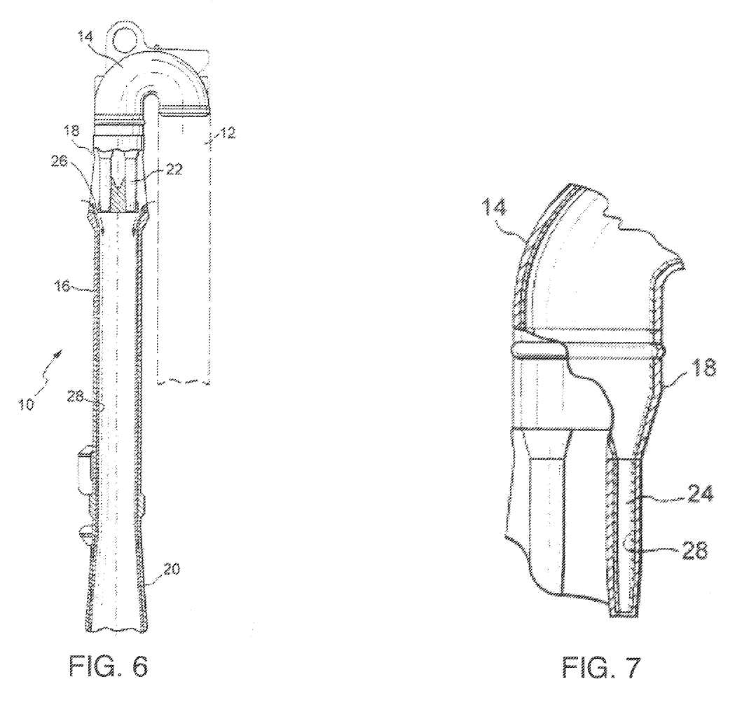

FIG. 6 schematically represents a portion of a jet pump 10 of a type used in a coolant recirculation system of a boiling water nuclear reactor as one example of an application of the coating of the invention for reducing accumulation of radioactive species on a metallic surface. The jet pump 10 can be one of any number of jet pumps typically located in an annular space between a wall of a reactor pressure vessel and a core shroud of the reactor. The annular space contains coolant that is circulated by the jet pumps around the nuclear reactor core. The jet pump 10 is represented in FIG. 6 as comprising an inlet riser 12 (represented in phantom) through which coolant is drawn from a suitable source, for example, a recirculation pump that draws coolant from the annular space. The riser 12 is represented as connected via an elbow 14 to a mixer assembly that includes a mixer 16 downstream of a nozzle assembly 18. A diffuser assembly 20 is located downstream of the mixer 16 and conducts the coolant to, for example, a lower core plenum of the reactor for delivery to the fuel rods of the reactor. While a single mixer assembly is shown in FIG. 6, the inlet riser 12 may be connected to a pair of mixer assemblies, with the second mixer assembly being similarly configured and located on the opposite side of the riser 12.

As evident from FIGS. 6 and 7, the nozzle assembly 18 has multiple nozzles 22, each defining an orifice 24 (FIG. 7). The walls of the nozzles 22 defining the orifices 24 are generally frustoconical in shape, with diameters decreasing in the direction of the coolant flow to increase the flow velocity of the coolant into the mixer 16. The interior passage of the mixer 16 generally has a more constant cross-sectional shape and size. The surfaces of the mixer 16 and nozzles 22 contacting the coolant are typically formed of a stainless steel, a notable but nonlimiting example being AISI Type 304, though it should be understood that these components can be formed of other materials, including other iron-base alloys as well as nickel-base alloys. Other details and aspects of the jet pump 10 and recirculation systems in which it may be installed are generally known in the art and therefore will be discussed in any further detail here.

As a result of being pumped by the recirculation pump, the coolant flows in an upward direction through the riser 12, through the elbow 14, and then downward through the nozzle assembly 18 and its orifices 24 into the mixer 16. The orifices 24 accelerate the coolant flow into the mixer 16 as well as draw coolant from the surrounding annular space into the mixer 16 through an annular-shaped inlet 26 that surrounds the nozzle assembly 18, causing mixing of the accelerated coolant with the coolant drawn from the annular space. The coolant, typically at temperatures of about 250 to about 350° C., is constantly circulated through the jet pump 10, with the result that the jet pump 10 (and other components of the recirculation system) are subject to fouling that results from charged particles within the hot coolant (typically water) tending to deposit onto the surfaces of the components, and in particular the surfaces that define the interior coolant passages of the mixer 16 and nozzles 22. Accumulation of such deposits eventually results in fouling, generally in the formation of a thick, dense oxide “crud” layer on the component surfaces, which poses operational and maintenance issues as a result of the degradation of coolant flow efficiencies. The coating of the invention reduces or eliminates the buildup of “crud” containing radioactive species on components that are exposed to high temperature water environments, for example, nozzles and throat areas of jet pump assemblies, impellers, condenser tubes, recirculating pipes, and steam generator parts in boiling water nuclear reactors.

While the invention has been described in terms of a preferred embodiment, it is apparent that other forms could be adopted by one skilled in the art. Therefore, the scope of the invention is to be limited only by the following claims.

1. A method of forming an oxide coating, comprising:
depositing an aqueous colloidal suspension containing about 0.5 to about 35 weight percent of nanoparticles comprising one of titania and zirconia on a metallic surface;
drying the aqueous colloidal suspension to form a green coating; and
heating the green coating to a temperature of up to 500° C. to densify the green coating and form an oxide coating on the metallic surface,
whereby the oxide coating has a zeta potential less than or equal to an electrical polarity of charged particles in contact with the oxide coating so as to minimize deposition of the charged particles on the metallic surface.

2. The method according to claim 1, wherein the nanoparticles have a diameter of up to about 200 nanometers.

3. The method according to claim 1, wherein the aqueous colloidal suspension further contains about 0.1% to about 10% of 2-[2-(2-methoxyethoxy)ethoxy]acetic acid (C₇H₁₄O₅) or polyfluorosufonic acid in water.

4. The method according to claim 1, wherein the aqueous colloidal suspension is deposited by immersing the metallic surface in the aqueous colloidal suspension for a duration of about 1 minute to about 120 minutes and at a temperature of about 25 to about 35° C.

5. The method according to claim 1, wherein the metallic surface is withdrawn from the aqueous colloidal suspension at a rate of about 1.0 to about 10.0 centimeters/minute.

6. The method according to claim 1, wherein the aqueous colloidal suspension is air dried at a temperature of about 25° C. to about 35° C. for a duration of about 5 minutes to about 60 minutes.

7. The method according to claim 1, wherein the green coating is heated to a temperature of about 100° C. to 500° C. for a duration of about 30 minutes to about 3 hours.

8. The method according to claim 1, wherein the green coating is heated at a rate of about 1.0° C./minute to about 10.0° C./minute.

9. The method according to claim 1, wherein the oxide coating exhibits an adhesion strength of at least 70 MPa to the metallic surface.

10. An oxide coating formed by the method of claim 1.

11. A method of forming an oxide coating for inhibiting deposition of charged particles on a metallic surface of an object, the method comprising:
preparing an aqueous colloidal suspension containing about 0.5 to about 35 weight percent of nanoparticles that contain at least one of titania and zirconia, and about 0.1% to about 10% of 2-[2-(2-methoxyethoxy)ethoxyl]acetic acid (C₇H₁₄O₅) or polyfluorosufonic acid in water;
immersing a metallic object in the aqueous colloidal suspension for a duration of about 1 to about 120 minutes;
withdrawing the metallic object from the aqueous colloidal suspension at a rate of about 1 to about 10 centimeters/minute;
air drying the aqueous colloidal suspension to form a green coating on the metallic surface; and
heating the green coating to a temperature of up to 500° C. to densify the green coating and form an oxide coating with a thickness of about 0.1 to about 10.0 micrometers and a zeta potential less than or equal to an electrical polarity of charged particles in contact with the metallic object so as to minimize deposition of the charged particles on the metallic object.

12. The method according to claim 11, wherein the nanoparticles have a diameter of up to about 200 nanometers.

13. The method according to claim 11, wherein the green coating is heated to a temperature of 100° C. to 120° C. for a duration of about 45 minutes to about 1 hour.

14. The method according to claim 11, wherein the aqueous colloidal suspension is air dried at a temperature of about 25° C. to about 35° C. for a duration of about 5 minutes to about 60 minutes.

15. The method according to claim 11, wherein the green coating is heated to a temperature of about 100° C. to 500° C. for a duration of about 30 minutes to about 3 hours.

16. The method according to claim 11, wherein the green coating is heated at a rate of about 1.0° C./minute to about 10.0° C./minute.

17. The method according to claim 11, wherein the oxide coating exhibits an adhesion strength of at least 70 MPa to the metallic surface.
